(19) United States
(12) Patent Application Publication
(10) Pub. No.: US 2011/0121518 A1
(43) Pub. Date: May 26, 2011

(54) SILICON CARBIDE MECHANICAL SEAL

(75) Inventor: David Peng, Fengshan City (TW)

(73) Assignee: CHAIR MAN HI-TECH Co., Ltd., Fengshan City (TW)

(21) Appl. No.: 12/626,260

(22) Filed: Nov. 25, 2009

(51) Int. Cl. F16J 15/34

(52) U.S. Cl. 277/404

(57) ABSTRACT

A SIC mechanical seal including a main body made of SIC materials. The main body includes a fixing portion and a pushed surface. The seal also includes a retainer including a shaft coupling seat, a push ring and an elastic part; of which the push ring is made of SIC material, and provided with a ring surface that's riveted to the pushed surface of the main body. The seal also includes at least an area of lower friction, set globally or locally onto either the pushed surface of the main body or the ring surface of the push ring. The friction of this area is less than that of the main body and the push ring. The area of lower friction is of a composite layer which is made of a mixture of SIC and carbon materials, or composed of multiple dents arranged at interval.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a silicon carbide mechanical seal, and more particularly to an innovative one which is configured with a pushed surface and an area of lower friction.

2. Description of Related Art Including Information Disclosed Under 37 CFR 1.97 and 37 CFR 1.98

Sanna refers to a device used to prevent the leakage of fluids (often referred to as lubricant) along a rotating shaft.

The mechanical seal is categorized into O-ring, oil seal, gasket and labyrinth metal seal, or divided according to different materials and pressures in tune with varying applications.

The present invention aims to provide an improved structure of SIC mechanical seal, which features high hardness, high heat resistance and extremely strong abrasion resistance. Given the fact that the hardness of SIC(silicon carbide) is close to that of diamond, if 100% SIC powder of high performance is to be sintered until reaching almost theoretical density (3.21 g/cm) at normal pressure, this could only be implemented under the conditions above 2000° C. and 350 MPa. At present, some non-oxide combustion supporters are added to reduce the sintering temperature of SIC around 2000° C. along with almost the normal pressure, SIC could reach the theoretical density 98%, so SIC presents extremely strong covalent bond, making it possible to maintain excellent performance at 1650° C. This is because extremely high structural density and super-high hardness lead to high abrasion resistance of SIC, and extremely compact structure (lower porosity) and extremely strong covalent bond(chemical inertness) lead to higher resistance to corrosion and oxidation, making it possible to operate normally even in strong acid and alkaline environment.

Despite of its higher abrasion resistance and extremely lower porosity, the intensive friction with the push ring of the retainer will affect the smoothness of the rotating shaft, leading to excessively high temperature and shorter service life of the mechanical seal.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production, development and design of related products.

### BRIEF SUMMARY OF THE INVENTION

Based on the unique configuration of “an improved structure of SIC mechanical seal” of the present invention that an area of lower friction is set onto either of the pushed surface of the main body or the ring surface of the push ring, the friction of this area is less than that of the main body and push ring, making it possible to reduce markedly the friction of SIC mechanical seal, improve the smoothness of the rotating shaft and extend the service life of the mechanical seal.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a cross-sectional view of the preferred embodiment of the present invention.

FIG. 2 shows a perspective cross-sectional view of the preferred embodiment of the present invention.

FIG. 3 shows a perspective cross-sectional view of another preferred embodiment of the area of lower friction of the present invention.

FIG. 4 shows an isolated view of another preferred embodiment of the area of lower friction of the present invention.

FIG. 5 shows an isolated view of the other preferred embodiment of the area of lower friction of the present invention.

### DETAILED DESCRIPTION OF THE INVENTION

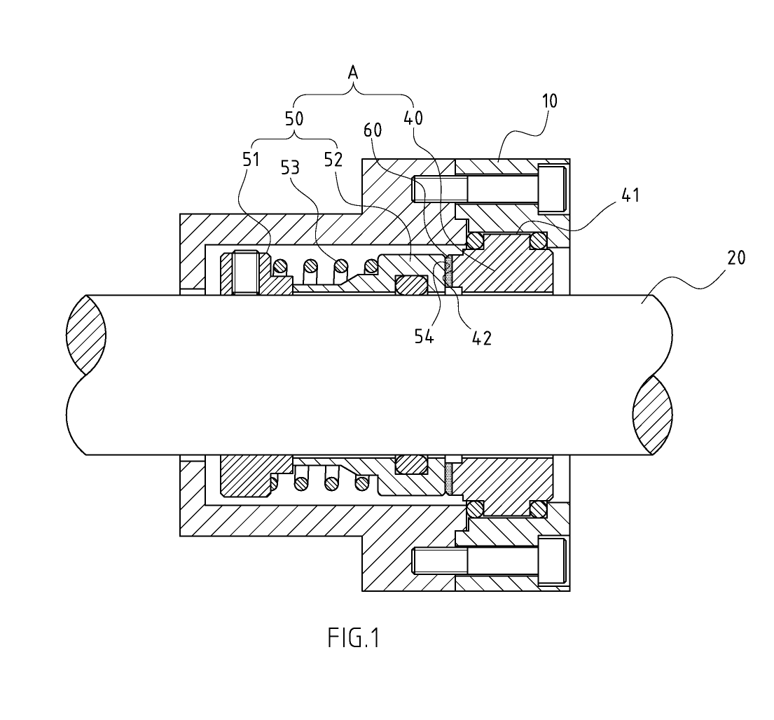

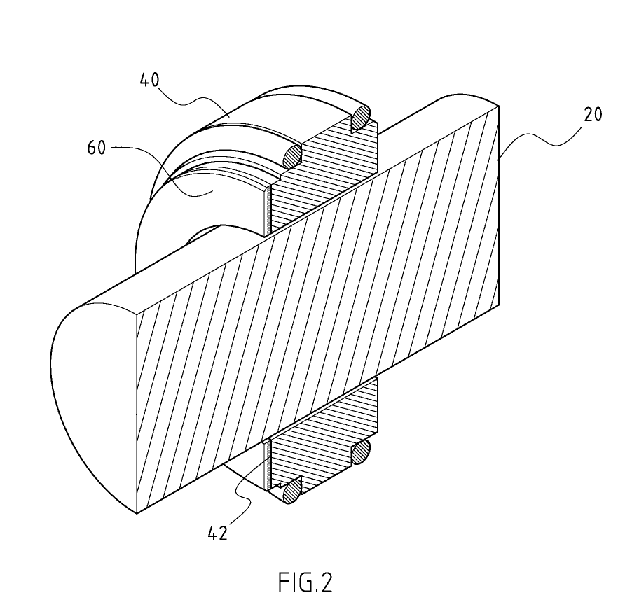

FIGS. 1 and 2 depict preferred embodiments of a SIC mechanical seal of the present invention which are provided for only explanatory objective for patent claims. The actual assembly state of SIC mechanical seal A is disclosed in FIG. 1, wherein SIC mechanical seal A is assembled fixedly into a bushing 10, and also coupled externally onto a rotating shaft 20.

The SIC mechanical seal A includes a main body 40, made of SIC material in a solid ring pattern. The main body 40 consists of a fixing portion 41 and a pushed surface 42. A retainer 50, includes a shaft coupling seat 51, a push ring 52 and an elastic part 53 (e.g. a helical spring) supported between the shaft coupling seat 51 and push ring 52, of which the shaft coupling seat 51 is coupled securely with the rotating shaft 20 for synchronous movement. The push ring 52 is made of SIC material in a solid ring pattern, and provided with a ring surface 54 that's riveted to the pushed surface 42 of the main body 40.

The SIC mechanical seal A also includes at least one area of lower friction 60, set globally or locally onto either the pushed surface 42 of the main body 40 or the ring surface 54 of the push ring 52. The friction of this area 60 is less than that of the main body 40 and the push ring 52. When the rotating shaft 20 is activated, the shaft coupling seat 51, push ring 52 and elastic part 53 of the retainer 50 are synchronized with the rotating shaft 20, but the main body 40 is fixed within the bushing 10, resulting in staggered friction between the ring surface 54 of the push ring 52 and the pushed surface 42 of the main body 40. So the area of lower friction 60 is aimed to reduce the degree of friction and abrasion.

Referring to FIGS. 1 and 2, the area of lower friction 60 is of a composite layer which is made of a mixture of SIC and carbon materials with a weight ratio of 0.5% to 50%. So, the friction of the pushed surface 42 can be reduced due to lower friction of the carbon materials. Alternatively, the area of lower friction 60 is of a composite layer which is made of a mixture of SIC and graphite with a weight ratio of 0.5% to 50%.

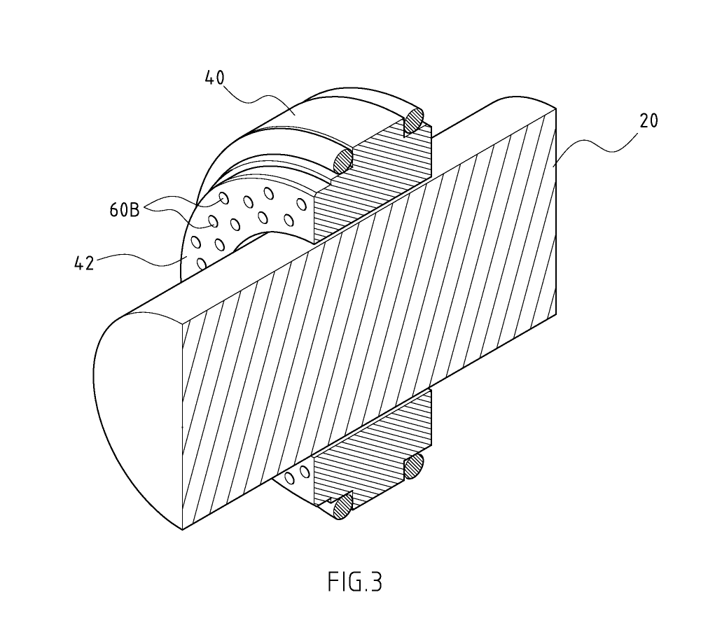

Referring also to FIG. 3, the area of lower friction 60B is composed of multiple dents arranged at interval on the pushed surface 42 of the main body 40 (or the ring surface 54 of the push ring 52). Said dent is available with either of groove, recess or coarse surface; with these structural characteristics of the recessed area of lower friction 60B, it is possible to cut down the frictional area (i.e. friction) on the pushed surface 42.

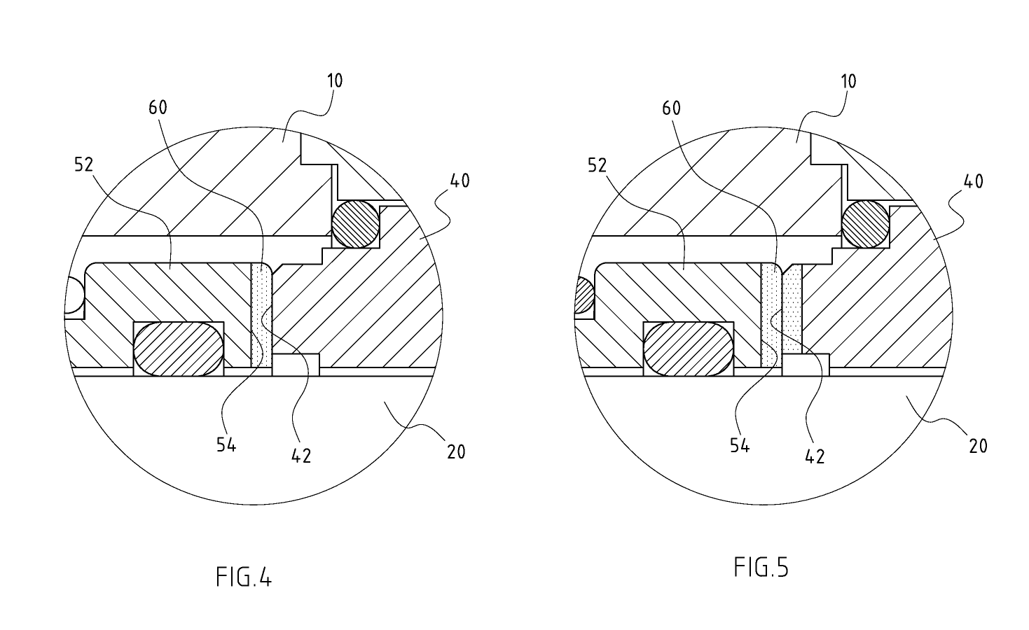

Referring to FIG. 4, the area of lower friction 60 is only arranged on the ring surface 54 of the push ring 52.

Referring to FIG. 5, the area of lower friction 60 is arranged on both the pushed surface 42 of the main body 40 and the ring surface 54 of the push ring 52.

1. An improved structure of SIC mechanical seal comprising:
a main body, made of SIC material in a solid ring pattern; the main body comprising a fixing portion and a pushed surface;
a retainer, comprising a shaft coupling seat, a push ring and an elastic part supported between the shaft coupling seat and push ring; of which the push ring is made of SIC material in a solid ring pattern, and provided with a ring surface that is riveted to the pushed surface of the main body; and
at least an area of lower friction, set globally or locally onto either the pushed surface of the main body or the ring surface of the push ring; the friction of this area is less than that of the main body and the push ring.

2. The structure defined in claim 1, wherein the area of lower friction is of a composite layer which is made of a mixture of SIC and carbon materials with a weight ratio of 0.5% to 50%.

3. The structure defined in claim 1, wherein the area of lower friction is of a composite layer which is made of a mixture of SIC and graphite with a weight ratio of 0.5% to 50%.

4. The structure defined in claim 1, wherein the area of lower friction is composed of multiple dents arranged at interval on the pushed surface of the main body.

5. The structure defined in claim 4, wherein said dent is available with either of groove or recess.

6. An improved structure of SIC mechanical seal, of which SIC mechanical seal comprising:
a main body, made of SIC material in a solid ring pattern; the main body comprising a fixing portion and a pushed surface; and
at least an area of lower friction, set globally or locally onto the pushed surface of the main body; the friction of this area is less than that of the main body.

7. The structure defined in claim 6, wherein the area of lower friction is of a composite layer which is made of a mixture of SIC and carbon materials with a weight ratio of 0.5% to 50%.

8. The structure defined in claim 6, wherein the area of lower friction is of a composite layer which is made of a mixture of SIC and graphite with a weight ratio of 0.5% to 50%.

9. The structure defined in claim 6, wherein the area of lower friction is composed of multiple dents arranged at interval.

10. The structure defined in claim 9, wherein said dent is available with either of groove or recess.
